(19) United States
(12) Patent Application Publication
(10) Pub. No.: US 2016/0079784 A1
(43) Pub. Date: Mar. 17, 2016

(54) BATTERY CHARGER

(71) Applicant: EnerSys Delaware, Inc., Reading, PA (US)

(72) Inventor: William C. Colley, III, Oberlin, OH (US)

(21) Appl. No.: 14/485,112

(22) Filed: Sep. 12, 2014

(51) Int. Cl. H02J 7/00; H02M 1/42; H02M 7/06

(52) U.S. Cl. CPC H02J 7/0052; H02M 7/06; H02M 1/4216; H02J 2007/0059

(57) ABSTRACT

A device with power factor correction for converting three-phase alternating-current power into direct-current power includes a DC to DC power converter, a first set of three diodes, a second set of three diodes, an input capacitor connected to the power converter, an input resistor disposed between the second set of diodes and the power converter, and a differential amplifier connected to the second set of diodes, a non-inverting input connected to the power converter, a negative power voltage connected to the power converter, a positive power voltage connected to the power converter, and an output connected to the power converter driving the power converter toward the sensed current at the inverting input and the non-inverting input being proportional to the voltage across the positive power voltage and negative power voltage.

### BACKGROUND

This invention relates in general to power supplies. One type of power supply is the power converter. Power converters include AC-to-DC convertor, DC-to-DC converters, and combinations thereof.

There is shown in FIG. 1 a schematic diagram of a known device 110 for power conversion. The device 110 includes a DC-to-DC power converter 112 having a positive input 114, negative input 116, a positive output 118, and a negative output 120. A positive lead 122 is in electrical communication with the positive output 118 and connected to a positive terminal 124 of a load 126. A negative lead 128 is in electrical communication with the negative output 120 and connected to a negative terminal 130 of the load 126.

The cathodes of a first set of three diodes 132 are in electrical communication with the positive input 114. The anodes of the first set 132 are each connected to an AC power source in a first, second and third phase, respectively. The anodes of a second set of three diodes 134 are in electrical communication with the negative input 116. The cathodes of second set 134 are connected to the AC power source in the first, second and third phase, respectively.

An input capacitor 136 is connected to the positive input 114 and the negative input 116. An output capacitor 138 is connected to the positive output 118 and the negative output 120.

In operation, the device 110 will convert AC current to DC current and convert an input voltage to into an output current driven into the load 126.

There is shown in FIG. 2 a second known device 140, which is similar to the first device 110 of FIG. 1, except as described below. Similar items are unlabeled or have been labeled with similar numerical identifiers. The second device 140 includes and output resistor 142 disposed between the negative output 120 and the negative terminal 130 of the load 126. An output compensation amplifier 144 is connected to each end of the output resistor 142 and connected to the power converter 112.

In operation of the device 140, the output resistor 142 and the output compensation amplifier 144 that operate as a current sensor on the output of the power converter 112 and control the power converter 112 to try to make the load current more constant over variations in the voltage across the input capacitor 136.

Referring to FIG. 3, the upper portion of the graph shows the current in one input phase for an input voltage of 480V RMS, an input capacitance of 6.9 μF, and a load of 3600 W, such as with a device 110 of FIG. 2. The lower portion of the graph shows the current drawn by a 3600 W resistive load. The power factor of the upper trace is 94.8%. The power factor of the lower trace is 95.6%.

FIG. 4 shows the graphs of similar testing, except at 1200 W. Note that for the upper portion the power factor is 91.8%. For the lower portion, the power factor is 95.6%.

### SUMMARY

This invention relates to power factor correction for converting three-phase alternating-current power into direct-current power. In one embodiment, a power converter provides the direct-current power for charging a battery.

In one embodiment, a device with power factor correction for converting three-phase alternating-current power into direct-current power includes a DC to DC power converter, a first set of three diodes, and a second set of three diodes. An input capacitor is connected to the power converter. An input resistor is disposed between the second set of diodes and the power converter. A differential amplifier is connected to the second set of diodes. A non-inverting input connected to the power converter, a negative power voltage connected to the power converter, a positive power voltage connected to the power converter, and an output connected to the power converter. The output drives the power converter toward the sensed current at the inverting input and the non-inverting input being proportional to the voltage across the positive power voltage and negative power voltage.

In another embodiment a device with power factor correction for converting three-phase alternating-current power into direct-current power for charging a battery includes a DC to DC power converter having a positive input, negative input, a positive output and a negative output. A positive lead is in electrical communication with the positive output of the power converter and connectable to the positive terminal of a battery. A negative lead is in electrical communication with the negative output of the power converter and connectable to the negative terminal of the battery.

Each cathode of a first set of diodes is in electrical communication with the positive input of the power converter. The anodes of the first diodes are connectable to an AC power source in a first, second and third phase, respectively. Each anode of a second set of diodes is in electrical communication with the negative input of the power converter. The cathodes of second set of diodes are connectable to the AC power source in the first, second and third phase, respectively.

An input capacitor is connected to the positive input of the power converter and the negative input of the power converter. An input resistor is disposed between the anodes of the second set of diodes and the negative input of the power converter.

A differential amplifier has an inverting input connected to the anodes of the second set of diodes, a non-inverting input connected to the negative input of the power converter, a negative power voltage connected to the negative input of the power converter, a positive power voltage connected to the positive input of the power converter, and an output connected to the power converter. The output of the differential amplifier drives the power converter toward the sensed current at the inverting input and the non-inverting input being proportional to the voltage across the positive power voltage and negative power voltage.

The differential amplifier may includes division in a compensation block of K*V/(AVG(V))², where K is a proportionality factor.

The proportionality factor may be a predetermined value.

An output capacitor may be connected to the positive output of the power converter and the negative output of the power converter.

An output resistor may be disposed between the negative output and the negative terminal of the battery.

An output compensation amplifier may be connected to each end of the output resistor and connected to the differential amplifier at a proportionality input.

The proportionality factor may be determined by a signal at the proportionality input of the differential amplifier.

Various aspects will become apparent to those skilled in the art from the following detailed description and the accompanying drawings.

### BRIEF DESCRIPTION OF THE DRAWINGS

FIG. 1 is a schematic diagram of a known device for power conversion.

FIG. 2 is a schematic diagram of a device similar to the device of FIG. 1, except including an output resistor and an output compensation amplifier.

FIG. 3 is a graph of the current flow and the current draw in one input phase of the device of FIG. 2.

FIG. 4 is a graph of a current flow and a current draw similar to FIG. 3, except at a different power level.

FIG. 5 is a schematic diagram of a first embodiment of a device for power conversion.

FIG. 6 is a schematic diagram similar to FIG. 5, except showing a device of a second embodiment.

FIG. 7 is a graph of the input current waveform of an operation of the device of FIG. 6.

FIG. 8 is a graph of the output current waveform of the operation of FIG. 7.

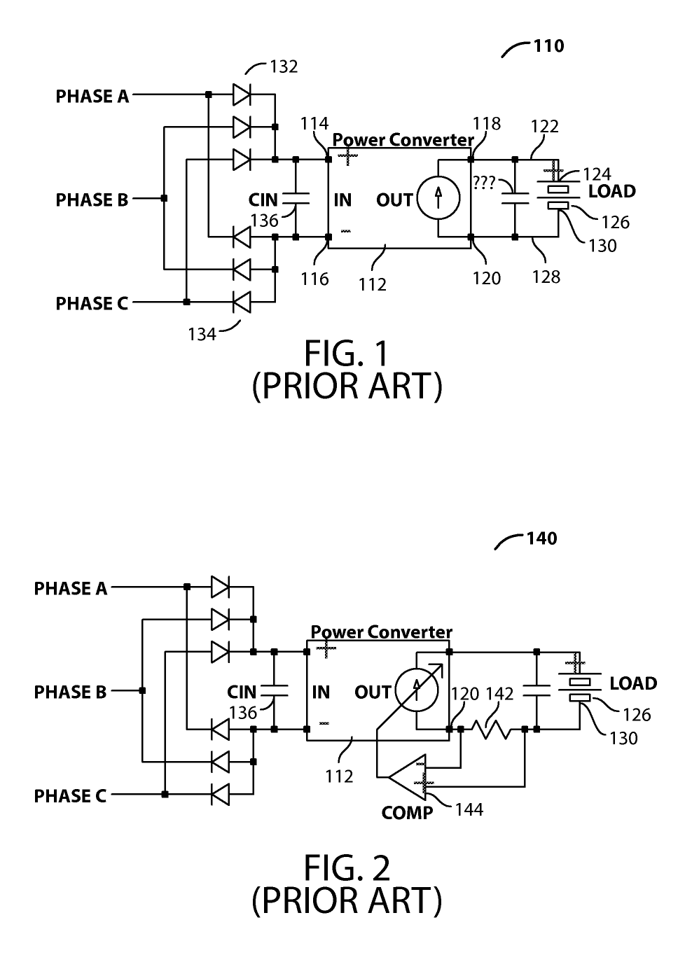

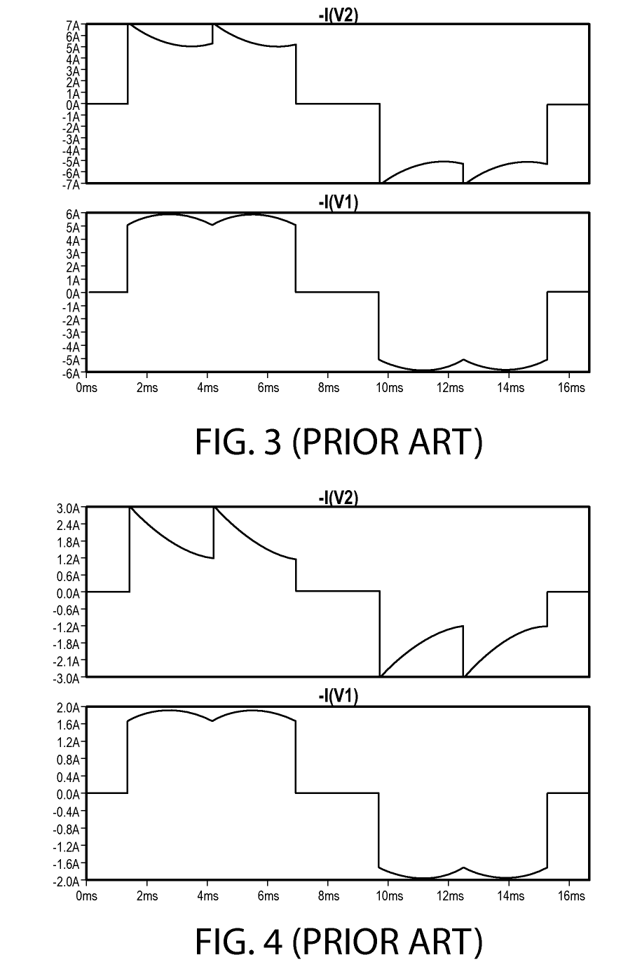

### DETAILED DESCRIPTION

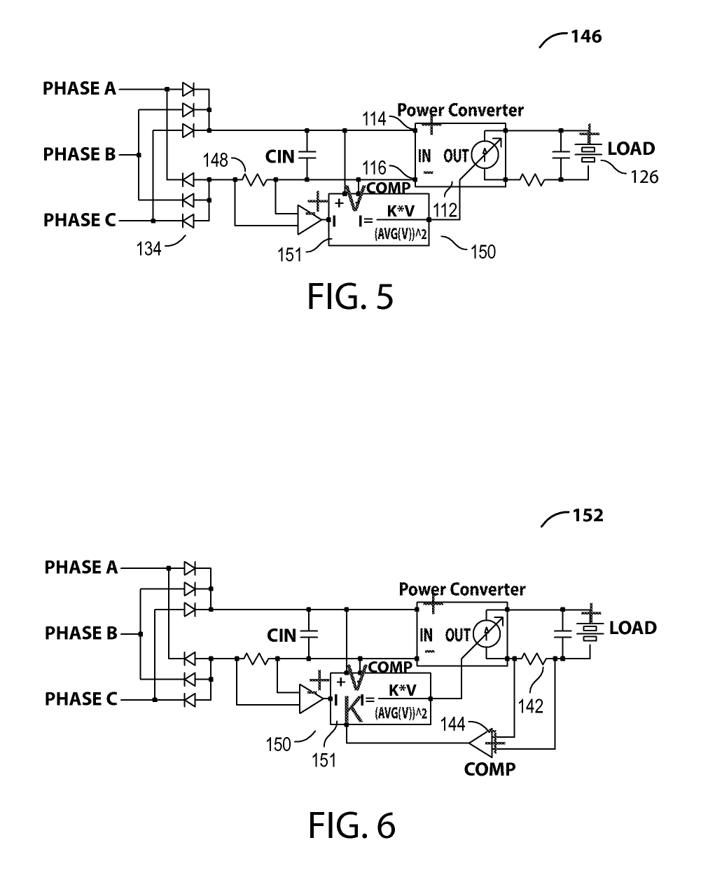

Referring again to the drawings, there is illustrated in FIG. 5 a device 146 with power factor correction for converting three-phase alternating-current power into direct-current power. Items similar to items discussed above are unlabeled or have been labeled with similar numerical identifiers.

An input resistor 148 disposed between the anodes of the second set of diodes 134 and the negative input 116 of the power converter 112.

A differential amplifier 150 has an inverting input connected to the anodes of the second set of diodes 134. A non-inverting input of the differential amplifier 150 is connected to the negative input 116 of the power converter 112. A negative power voltage of the differential amplifier 150 is connected to the negative input 116 of the power converter 112. A positive power voltage of the differential amplifier 150 is connected to the positive input 114 of the power converter 112. An output of the differential amplifier 150 is connected to the power converter 112. A signal from the output of the differential amplifier 150 drives the power converter toward the sensed current at the inverting input and the non-inverting input of the differential amplifier 150 is being proportional to the voltage across the positive power voltage and negative power voltage of the differential amplifier 150.

The device 146 includes a compensation block 151. In the illustrated embodiment, the differential amplifier 150 includes division in the compensation block 151 of K*V/(AVG(V))², where K is a proportionality factor. For example, this proportionality factor may be predetermined.

With reference to FIG. 6, there is illustrated a second device 152 with power factor correction for converting three-phase alternating-current power into direct-current power. Items similar to items discussed above are unlabeled or have been labeled with similar numerical identifiers.

The output compensation amplifier 144 is connected to each end of the output resistor 142 and connected to the differential amplifier 150 at a proportional input.

The proportionality factor K may be determined by a signal at the proportionality input of the differential amplifier 150.

In one exemplary method for controlling the power factor of a power converter, power is fed from a 3-phase diode bridge rectifier. The power converter is controlled such that the current drawn through the diode bridge is similar to the current drawn by a resistive load through a diode bridge. For example, this resistive load may be the charging of a battery.

In one operation, a power converter is driven such that a sensed current at an input side of the power converter is proportional to a voltage across an input capacitor across inputs of the power converter. In at least one case, a proportionality factor may be adjusted to achieve the foregoing.

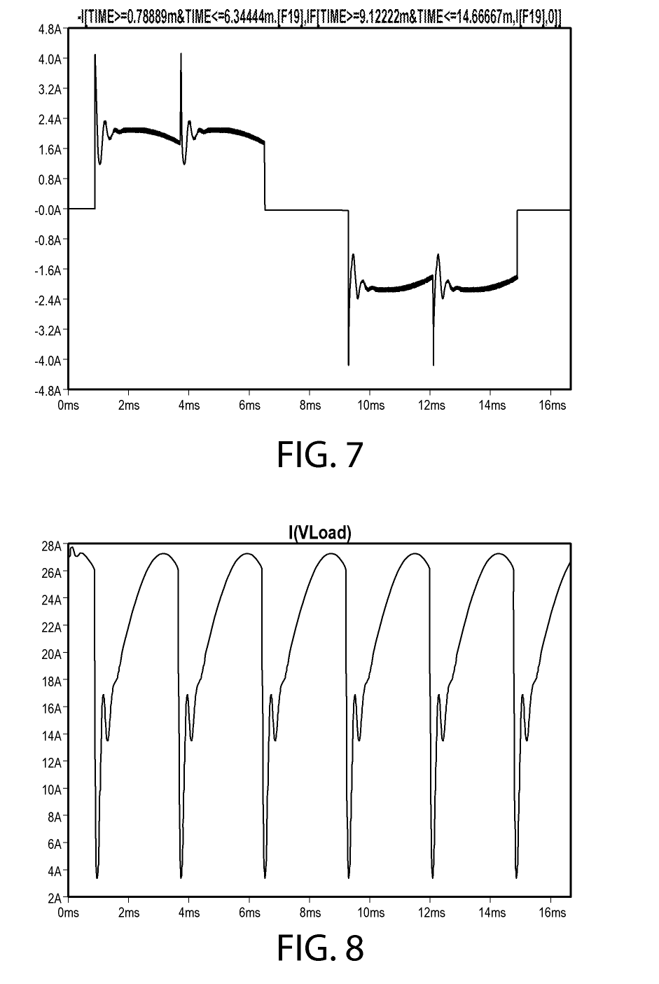

Referring to FIGS. 7 and 8, for example, there is shown from one operation, a graph of the input current waveform of this operation in FIG. 7 and a graph of the output current waveform of the operation in FIG. 8. This operation was performed at 1200 W. The resultant power factor is 94.9%

While principles and modes of operation have been explained and illustrated with regard to particular embodiments, it must be understood, however, that this may be practiced otherwise than as specifically explained and illustrated without departing from its spirit or scope.

What is claimed is:

1. A device with power factor correction for converting three-phase alternating-current power into direct-current power for charging a battery, comprising:
a DC to DC power converter having a positive input, negative input, a positive output and a negative output;
a positive lead in electrical communication with the positive output of the power converter and connectable to the positive terminal of a battery;
a negative lead in electrical communication with the negative output of the power converter and connectable to the negative terminal of the battery;
a first set of three diodes, each of the first diodes having an anode and a cathode, each cathode of the first diodes in electrical communication with the positive input of the power converter, the anodes of the first diodes connectable to an AC power source in a first, second and third phase, respectively;
a second set of three diodes, each of the second diodes having an anode and a cathode, each anode of the second diodes in electrical communication with the negative input of the power converter, the cathodes of second diodes connectable to the AC power source in the first, second and third phase, respectively;
an input capacitor connected to the positive input of the power converter and the negative input of the power converter;
an input resistor disposed between the anodes of the second set of diodes and the negative input of the power converter; and
a differential amplifier having an inverting input connected to the anodes of the second set of diodes, a non-inverting input connected to the negative input of the power converter, a negative power voltage connected to the negative input of the power converter, a positive power voltage connected to the positive input of the power converter, and an output connected to the power converter driving the power converter such that the sensed current at the inverting input and the non-inverting input is proportional to the voltage across the positive power voltage and negative power voltage.

2. The device of claim 1 where the differential amplifier includes division in a compensation block of K*V/(AVG(V))², where K is a proportionality factor.

3. The device of claim 2 where the proportionality factor is a predetermined value.

4. The device of claim 1 further comprising an output capacitor connected to the positive output of the power converter and the negative output of the power converter.

5. The device of claim 1 further comprising an output resistor disposed between the negative output and the negative terminal of the battery.

6. The device of claim 5 further comprising an output compensation amplifier connected to each end of the output resistor and connected to the differential amplifier at a proportionality input.

7. The device of claim 6 where the differential amplifier includes division in a compensation block of K*V/(AVG(V))², where K is a proportionality factor.

8. The device of claim 7 where the proportionality factor is a determined by a signal at the proportionality input of the differential amplifier.

9. A device with power factor correction for converting three-phase alternating-current power into direct-current power for a load, comprising:
a DC to DC power converter having a positive and negative inputs, and positive and negative outputs;
a load connected to the outputs of the power converter;
a first set of diodes, connected to the positive input of the power converter, and connected to an AC power source;
a second set of diodes, connected to the negative input of the power converter, and connected to the AC power source;
an input capacitor connected to the inputs of the power converter;
an input resistor disposed between one of the sets of diodes and the power converter; and
a differential amplifier connected to at least one set of diodes and the inputs of the power converter;
where an output of the differential amplifier drives the power converter toward sensed current at the inputs of the power converter being proportional to a voltage across the inputs of the power converter.

10. The device of claim 9 where the load is a battery.

11. The device of claim 9 where the first and second set of diodes each include three diodes that are each connected to the AC power source in a first, second and third phase, respectively.

12. The device of claim 9 where the input resistor is disposed between the first set of diodes and the power converter.

13. The device of claim 9 where the input resistor is disposed between the second set of diodes and the power converter.

14. The device of claim 9 where the differential amplifier includes division in a compensation block of K*V/(AVG(V))², where K is a proportionality factor.

15. The device of claim 14 where the proportionality factor is a predetermined value.

16. The device of claim 9 further comprising an output capacitor connected to the outputs of the power converter.

17. The device of claim 9 further comprising an output resistor disposed between one of the outputs of the power converter and the load.

18. The device of claim 17 further comprising an output compensation amplifier connected to each end of the output resistor and connected to the differential amplifier to provide a proportionality input.

19. The device of claim 18 where the differential amplifier includes division in a compensation block of K*V/(AVG(V))², where K is a proportionality factor.

20. The device of claim 19 where the proportionality factor is a determined by the proportionality input.
